(19) United States
(12) Patent Application Publication
(10) Pub. No.: US 2004/0033374 A1
(43) Pub. Date: Feb. 19, 2004

(54) Phenolic adhesives for bonding peroxide-cured elastomers

(76) Inventor: Douglas H. Mowrey, Titusville, PA (US)

Correspondence Address: Lord Corporation, 111 Lord Drive, PO Box 8012, Cary, NC, 27512-8012, US

(21) Appl. No.: 10/222,545

(22) Filed: Aug. 16, 2002

(51) Int. Cl. B32B 15/04

(52) U.S. Cl. 428/457; 428/462; 428/472

(57) ABSTRACT

What is disclosed are bonded articles of a peroxide cured elastomer and a substrate which an adhesive composition that exhibits substantial environmental resistance and rubber tearing bonds. The invention is also directed to adhesives consisting essentially of water, a phenol-aldehyde condensate, an etherified bis phenol aldehyde adduct and PVOH colloid protectant, optional polymeric film former, acid scavenger and precipitated silica. The present invention is further directed to a method of bonding peroxide-curable elastomers to metallic surfaces whereby the substrate is coated with the adhesive composition, drying the adhesive composition coating, applying a peroxide-cured elastomer to the adhesive composition coating, and curing the assembly with heat and/or pressure.

### FIELD OF THE INVENTION

The present invention relates to adhesive bonded peroxide-cured elastomer to a substrate where the bonding takes place during the vulcanization of the elastomer. More specifically, the present invention relates to aqueous or solvent-based adhesive composition comprising a maleimide curing agent, film former, acid scavenger and a silicate.

### BACKGROUND OF THE INVENTION

In applications involving the bonding of elastomeric substrates to surfaces such as metal surfaces, an adhesive must exhibit an affinity for the elastomeric substrate as well as possess the ability to withstand degradation by a variety of agents, for example, exposure to invasive fluids or corrosive materials at elevated temperatures (collectively “environmental resistance”).

In the literature relating to adhesives for bonding rubber to metal (RTM), the following additives such as organosilanes, dispersing agents, adhesion promoting resins such as phenol formaldehyde, crosslinkers such as nitrosobenzenes, and maleimide compounds, carbon black, silica, calcium carbonate, oxides of the metals Al, Ca, Zn, Mg, Pb, Zr, also zirconium salts, e.g. zirconium aluminate, and lead salts of inorganic and/or organic acids, e.g. basic lead carbonate. The use of lead compounds is widely practiced in RTM adhesives because these materials impart essential heat and corrosion resistance of the bond between the vulcanized elastomer and the metal. Lead compounds useful as additive in RTM adhesives provide either an acid scavenging feature and/or corrosion resistance in conjunction with halogenated polymers. Due to the increasing demand from both government and industry to use adhesive materials that do not contain bio-accumulative ingredients. Conventional rubber-to-metal adhesives have required effective amounts of lead compounds and selenium to provide essential resistance to heat and corrosion. It would be desirable to provide adhesives for bonding of rubber to metal during the vulcanization processes that contain less than 1000 ppm of undesirable ingredients such as lead and selenium-containing compounds while at the same time providing comparable heat and corrosion resistance.

Various solvent-based and aqueous-based adhesives for bonding elastomeric materials have been developed in a continuing effort to obtain the ultimate aqueous adhesive for bonding elastomeric substrates. For example, U.S. Pat. No. 4,167,500 describes an aqueous adhesive composition that contains a water dispersible novolak phenolic resin, a methylene donor such as an acetal homopolymer or acetal copolymer, and water. The phenolic resins described are primarily derived from resorcinol and alkylphenols such as p-nonylphenol although various other polyhydroxy phenols are mentioned, such as phloroglucinol and pyrogallol.

U.S. Pat. No. 4,483,962 describes a latex of an emulsion-polymerized terpolymer of at least one 2,3-dihalo-1,3-butadiene monomer, at least one monoalkenyl aromatic alkylhalide monomer, and at least one olefinically unsaturated monomer. The terpolymer latex utilizes a surfactant such as an anionic surfactant or a mixture of an anionic surfactant and a non-anionic surfactant.

U.S. Pat. No. 4,988,753 describes an aqueous bonding composition containing (1) a mixture of chlorosulfonated polyethylene and vinyl chloride/vinvlidene chloride/acrylic acid copolymer, (2) an organic polynitroso compound, and (3) a coreactive compound selected from diallyl acrylamide and phenylene bis-maleic acid imide. The adhesive composition may also optionally contain adhesion promoters, fillers, and processing aids.

U.S. Pat. No. 5,036,122 describes an aqueous adhesive composition which is a blend of a latex of a polymerized conjugated diene, a poly-C-nitroso compound, and a maleimide compound, e.g., a bismaleimide.

For example, U.S. Pat. No. 3,258,388, discusses the incorporation of poly-C-nitroso aromatic compounds into conventional rubber-to-metal adhesives to improve bonding. The conventional adhesives into which these compounds may be incorporated include compositions containing thermo-setting condensation polymers; polymers and copolymers of polar, ethylenically unsaturated materials; halogenated rubbers; and polyisocyanates.

U.S. Pat. No. 3,282,883 discloses an adhesive composition that includes dinitrosobenzene, chlorosulphonated polyethylene, and an orthoalkoxy aryl diisocyanate. This composition is produced by dissolving and/or dispersing the components in an organic solvent. The composition is for bonding natural and synthetic rubbers, such as ethylene-propylene-nonconjugated diene terpolymers, neoprene, styrene-butadiene rubber, butyl rubber, halobutyl rubber, butadiene-acrylonitrile, halosulfonated polyethylene rubber, polyurethane rubber, and polyacrylate rubber. The rubbers may be bonded to themselves or to other substrates, such as metals.

U.S. Pat. No. 3,824,217 discloses combining an oxime compound with an excess of a polyisocyanate compound, so that all oxime groups are reacted with isocyanate. The resulting compound may be used in compositions for bonding rubbers to primed metal substrates.

U.S. Pat. No. 3,830,784 discloses an adhesive composition that includes a poly-C-nitroso aromatic compound, a polyisocyanate that is reactive at room temperature or greater, and an acidic halogen-containing polymer. The composition is produced by dissolving the acidic halogen-containing polymer and the aromatic polyisocyanate in an organic solvent, and the poly-c-nitroso aromatic compound is dispersed in the resulting solution. The resultant composition is shelf-stable and forms a strong adhesive bond between the substrate and the elastomer during vulcanization thereof.

U.S. Pat. No. 4,581,092 discloses a cold-vulcanizable adhesive system for bonding vulcanized rubbers. The system is of particular use in creating durable seams between rubber strips or sheets. The adhesive compositions include butyl rubber, a polyisocyanate compound, and at least one of a nitroso compound and an oxime compound, with the oxime compound requiring the additional presence of an oxidizing agent. DE 22 28 544 describes a binder for the production of composites by vulcanization of rubber mixtures onto metals or other stable substrates. In addition to chlorosulfonated polyethylene, chlorinated rubber, polyisocyanates and a phenolic resin, this binder also contains dinitrosobenzene in the form of a suspension in solvents.

U.S. Pat. No. 5,354,805 to Mowrey, et al discloses a single-coat adhesive composition for bonding nitrile rubber to a metal surface which comprises a chlorosulfonated polyethylene latex, a polyhydroxy phenolic novolak resin copolymer, and a high molecular weight aldehyde polymer wherein the phenolic resin copolymer is prepared by combining a monohydroxy and/or a dihydroxy aromatic compound, as a first phenolic component, with a trihydroxy aromatic compound, as a second phenolic component, and a formaldehyde source under reaction conditions sufficient to create the phenolic resin copolymer and wherein the high molecular weight aldehyde polymer is selected from the group consisting of acetal homopolymers, acetal copolymers, gamma-poloxymethylene ethers.

The prior art adhesive compositions for bonding sulfur-cured vulcanizable elastomers where bonding takes place during vulcanization suggest as an essential component one or more of a dinitroso compound, an oxime compound, a polyisocyanate compound, and an oxidizing agent. The toxicity of these ingredients poses handling and safety problems. When bonding peroxide-cured elastomers, it has been found that dinitroso compounds (e.g. poly-C nitroso), particularly poly(p-dinitrosobenzene, (poly DNB) or p-dinitrosobenzene (DNB) sublime at temperatures encountered in vulcanizing the elastomers.

U.S. Pat. No. 6,132,870 discloses a reinforced composite including an elastomer of low unsaturation, a reinforcing fiber, an adhesive composition that bonds the elastomer to the coated reinforcing fiber including a halogenated polyolefin, a nitroso compound, a maleimide, the maleimide present in an amount of at least 50% by weight of the halogenated polyolefin.

U.S. Pat. No. 5,200,455 discloses an aqueous primer composition. A primer requires an overcoat adhesive. The primer comprised a polyvinyl alcohol-stabilized aqueous phenolic novolak or resole resin dispersion, a latex of chlorosulfonated polyethylene, and a metal oxide. Commercially available primers containing phenolic resins similar to those taught in U.S. Pat. No. '455 have been commercially accepted. The exemplified primer coating adhesive utilized BKUA-2370 phenol resin based on bisphenol-A having a F/P ratio (aldehyde/phenolic) of from 2 to about 3.75 moles of formaldehyde per mole of bisphenol-A. As a primer coat-overcoat adhesive system, current products available in the market are observed to pass some of the performance targets but cement-to-metal adhesive failure is seen to occur in long term multi-stress testing. Improvements would be of industrial importance.

Thus, there remains a need for new adhesive compositions that are simple, safe, stable, and effective for the bonding of peroxide-cured elastomers to substrates, particularly metal and glass substrates. Effective adhesives will have high rubber retention under conventional peel tests, and good pre-bake resistance.

### SUMMARY OF THE INVENTION

The present invention is a one-coat aqueous adhesive composition that is poor in bonding sulfur-cured elastomers, but was found to be especially advantageous for bonding peroxide-cured elastomers, in that the bonded peroxide-cured elastomer using the adhesives according to the present invention exhibits environmentally resistant, rubber-tearing bonds between the peroxide cured rubber and substrates, especially metal substrates. The invention is also directed to adhesive bonded articles comprising peroxide cured elastomer, adhesive and substrate, wherein the bonding exhibits a high degree of rubber retention in bond failure, high peel strength, and an environmentally resistant adhesive bond. The adhesive is substantially absent a nitroso compound, and consists essentially of a aqueous carrier and a mixture of phenol-aldehyde condensate and etherified bis-phenol adduct dispersion with PVOH. In another aspect aqueous carrier and mixture of phenol-aldehyde condensate and etherified bis-phenol adduct dispersion with PVOH is combined with a film forming polymer and acid scavenger. The articles of the invention are bonded articles comprising a peroxide-cured elastomer bonded to a substrate, and as a single organic bonding layer between the elastomer and substrate, the adhesive layer comprises optionally a precipated silica, a bonding agent comprising a phenol-aldehyde resole, an etherified bis-phenol adduct dispersed with an aqueous protective colloid, and wherein said adhesive exhibits rubber tearing bonds between the vulcanizate of said peroxide-cured elastomer and substrate with said adhesive therebetween.

In a specific aspect of the invention there is provided rubber-to-metal adhesive system containing less than about 1000 ppm of lead and consisting essentially of chlorosulfonated polyethylene and/or chlorinated natural rubber, a pigment, silica, zinc phosphate, and a PVOH dispersion of a phenol-aldehyde condensate and an etherified bis-phenol-aldehyde adduct.

The present invention is further directed to a method of bonding a peroxide-curable elastomer to a metallic surface comprising coating the substrate with a single layer of the above adhesive composition, drying the adhesive composition, applying a peroxide-cured elastomer to the adhesive layer, and curing the assembly with heat and/or pressure.

The present invention is also directed to adhesive composition, and composite article of manufacture comprising a peroxide-cured elastomer bonded to a substrate with the adhesive composition.

In another aspect the present invention is further directed to a method of bonding peroxide-curable elastomers to metallic surfaces whereby the substrate is coated with the adhesive composition, drying the adhesive composition coating, applying a peroxide-cured elastomer to the adhesive composition coating, and curing the assembly with heat and/or pressure.

### DESCRIPTION OF THE PREFERED EMBODIMENTS

The peroxide-curable rubber substrates bonded by the invention are the conventional vulcanizable rubbers that must contain a peroxide as the curing agent. Although in a few special instances, both a sulfur-curing component and a peroxide curing component can both be present, there must be a peroxide curing agent present in the elastomers bonded according to the invention. The adhesive compositions of the present invention have been found to have surprising strong bonding characteristics when bonding peroxide cured elastomers. These elastomers are known to be difficult to bond to substrates, especially to metal substrates.

Surprisingly, it has been discovered that the adhesive compositions of the present invention provide excellent adhesion to peroxide-cured elastomeric materials formulated in numerous specific embodiments, widely available and beyond the scope of this disclosure. Examples of the peroxide-cured rubber used as vulcanizable rubber bonded according to the invention herein include the following:

Homopolymers of conjugated diene compound such as isoprene, butadiene, and chloroprene. Examples include polyisoprene rubber (IR), polybutadiene rubber (BR), natural rubber (NR) and polychloroprene rubber.

Copolymers of conjugated diene with a vinyl compound such as styrene, acrylonitrile, vinylpyridine, acrylic acid, methacrylic acid, alkyl acrylate, and alkyl methacrylate. Examples include styrene-butadiene copolymer rubber (SBR), vinylpyridine butadiene styrene copolymer rubber, acrylonitrile butadiene copolymer rubber (NBR), hydrogenated acrylonitrile butadiene copolymer rubber (HNBR).

ZSC-cured hydrogenated nitrile-butadiene rubber, acrylic acid—butadiene copolymer rubber, methacrylic acid butadiene copolymer rubber, methyl acrylate butadiene copolymer rubber, and methyl methacrylate butadiene copolymer rubber.

Copolymers of olefin with non-conjugated diene. Examples include EPDM rubbers, like ethylene-propylene-cyclopentadiene terpolymers, ethylene-propylene-5-ethylidene-2-norbornene terpolymers, and ethylene-propylene-1,4-hexadiene terpolymers.

Adhesive Film Former

In some embodiments a film forming polymer is used. The term “film former” as used herein refers to a polymer substance that will form a film and which wets out a substrate surface when formulated, to form a continuous skin when the aqueous carrier is removed upon drying. In aqueous embodiments, the film former is dispersed in water.

The preferred film formers are halogen-containing polymers including post-halogenated natural rubber and/or synthetic addition-polymerized, halogenated elastomer. The halogens employed in the halogenated elastomers will usually be chlorine or bromine, although fluorine can also be used. A combination of halogen atoms can also be employed in which case the halogen-containing polymer elastomer will have more than one halogen substituted thereon. Exemplary synthetic film formers are the halogen-containing polyolefinic elastomers. Their preparation is well known in the art and many types are available commercially. Representative halogen-containing polyolefinic elastomers include, but are not limited to chlorinated natural rubber, chlorinated polychloroprene, chlorinated polybutadiene, chlorinated butadiene-styrene copolymers, chlorinated ethylene propylene copolymers, chlorinated ethylene/propylene/non-conjugated diene terpolymers, chlorinated polyethylene, chlorosulfonated polyethylene, copolymers of α-chloroacrylonitrile and 2,3-dichloro-1,3-butadiene, brominated poly(2,3-dichloro-1,3-butadiene), copolymers of α-haloacrylonitriles and 2,3-dichloro-1,3-butadiene, chlorinated poly(vinyl chloride), vinyl chloride-vinylidene chloride-acrylate or acrylic acid terpolymers, and the like, including mixtures of such halogen-containing elastomers.

An exemplary mixture of film formers is chlorosulfonated polyethylene and chlorinated natural rubber. Thus, substantially any of the known halogen-containing derivatives of natural and synthetic elastomers are preferably employed in the practice of this invention, including mixtures of halogenated and non-halogenated elastomers. Chlorosulfonated polyethylene elastomers alone or in combination with chlorinated natural rubber are the most preferred mixed halogen-containing film formers. Chlorosulfonated polyethylene is commercially available from E. I. Du Pont de Nemours & Co. under the HYPALON® mark.

If chlorinated polyolefin (CPE) is employed as a primary film former, the chlorine content should be greater than about 60 percent and the CPE molecular weight greater than about 500. Such chlorine contents can be obtained by a process involving the dispersion and chlorination of high surface area polyolefinic particles in an aqueous medium taught in U.S. Pat. No. 5,534,991.

Chlorinated natural rubber is a preferred film former and several grades are commercially available from Bayer Aktiengesellschaft, under the PERGUT® mark.

Chlorosulfonated polyethylene latex typically has a molecular weight in the range of about 50,000-150,000, preferably about 60,000-120,000. The chlorine content of the chlorosulfonated polyethylene is typically in the range of about 20-50 wt. %, preferably about 25 to 45 wt. %, percent while the sulfur content is typically in the range of about 0.5 to 2, preferably about 1.0 to 1.5 percent.

In the embodiments containing a film former, the preferred halogenated polyolefin is typically utilized in an amount ranging from about 5.0 to 40.0, preferably about 10.0 to 20.0 percent by weight on a dry weight basis of the adhesive.

A latex of the halogenated polyolefin of the present invention can be prepared according to methods known in the art such as by dissolving the halogenated polyolefin in a solvent and adding a surfactant to the resulting solution. Water can then be added to the solution under high shear to emulsify the polymer. The solvent is then stripped to obtain a latex having a total solids content of from about 10 to 60, preferably 25 to 50, percent by weight. The latex can also be prepared by emulsion polymerization of chlorinated ethylenically unsaturated monomers.

The utilization of chlorinated natural rubber either in solvent solution or as a latex is most preferred in forming the adhesive of the present invention inasmuch as generally other types of rubbers, halogenated and non-halogenated, and the like do not result in as good pre-bake properties. Accordingly, other types of rubbers are less preferred film formers. Aqueous dispersions of halogenated or preferably chlorinated natural rubbers are made by conventional techniques for producing aqueous dispersions. Examples of suitable processes and chlorinated natural rubbers which can be utilized are set forth in U.S. Pat. Nos. 3,968,067; 4,070,825; 4,145,816; 4,243,566; and 6,103,786; the entire disclosure of each is hereby fully incorporated by reference. Generally the various processes involve dissolving the elastomer in an organic solvent, followed by forming a water-based dispersion thereof with the aid of a surfactant. Any remaining solvent can be removed as by steam stripping. The chlorinated natural rubber generally contains from about 60% to about 75% and desirably from about 65% to about 68% by weight of chlorine therein based upon the total weight of the natural rubber. The chlorinated natural rubber latex generally contains from about 25 to about 75 and desirably from about 40 to about 60 weight percent of solids. The amount of the film former polymer on a dry weight basis generally ranges from about 1 to about 50 weight %, preferably 5 to 40 weight % of the adhesive.

Aqueous Bonding Agent

The aqueous bonding agent is a colloidal dispersion of a mixture of phenolic-aldehyde condensate and an etherified bis-phenol-aldehyde adduct dispersed in a protective colloid. Various types of phenol and/or substituted phenols can be used as starting materials for the phenolic aldehyde resole component of the bonding agent.

“Phenolic compound” means a compound that includes at least one hydroxy functional group attached to a carbon atom of an aromatic ring. Illustrative phenolic compounds include unsubstituted phenol per se, substituted phenols such as alkylated phenols and multi-hydroxy phenols, and hydroxy-substituted multi-ring aromatics. Illustrative alkylated phenols include methylphenol (also known as cresol), dimethylphenol (also known as xylenol), 2-ethylphenol, pentylphenol and tert-butyl phenol; and multi-hydroxy phenols including 1,3-benzenediol (also known as resorcinol), 1,2-benzenediol (also known as pyrocatechol), 1,4-benzenediol (also known as hydroquinone), 1,2,3-benzenetriol (also known as pyrogallol), 1,3,5-benzenetriol and 4-tert-butyl-1,2-benzenediol (also known as tert-butyl catechol). Unsubstituted phenol provides three active sites (two ortho- and one para-) for substitution to form up to three alkylol moieties on the ring. A phenol molecule substituted on either position, such as o- or p-cresol, provide two active sites, and so on, as is well known.

The aldehydes which are suitable for condensing with the phenolic materials include formaldehyde, acetaldehyde, propionaldehyde, n-butylaldehyde, n-valeraldehyde, caproaldehyde, heptaldehyde, and straight-chain aldehydes having a carbon number up to about 8. Formaldehyde is the preferred aldehyde. The molar ratio of aldehyde (e.g., formaldehyde) to aromatic alcohol (e.g., phenol), the “F/P ratio”, in the phenolic condensate resin is between about 1 and about 2, more preferably is between about 1.1 and about 1.7, and most preferably is between about 1.2 and about 1.5 The F/P ratio is calculated on a “per aromatic ring” basis.

The adduct of aldehyde and a bis-phenol compound included in the bonding agent according to the invention is based on any compound, collectively referred to as a “bis-phenol”, having the following structure:

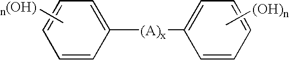

wherein A is a divalent aliphatic, cycloaliphatic or aromatic radical having 1 to 13 carbon atoms, or a thio, oxy, carbonyl, sulfonyl or sulfonyl radical. A is optionally substituted with one or more chlorine or fluorine atoms, x is 0 or 1, n is 1 or 2; the OH groups are attached at any position, and each aromatic ring may be optionally substituted with at least one C₁-C₈ alkyl, chlorine, fluorine, bromine, carboxyl or acyl radical (—COR) where R is H or a C₁-C₈ alkyl, -aryl, -or cycloalkyl group. Examples of starting materials include but are not limited to 2,2′-bis(3-bromo-4-hydroxyphenyl)-propane, 2,2′-bis(3,5-dichloro-4-hydroxyphenyl)propane, 2,2′-bis(3-chloro-4-hydroxyphenyl)propane, bis(4-hydroxyphenyl)-methane, bis(4-hydroxyphenyl)sulfone, bis(4-hydroxyphenyl)sulfide, and the like. The most preferred bis phenols are 2,2′-bis(4-hydroxyphenyl)propane, also referred to as 4,4′-isopropylidenebisphenol (bisphenol A) and bis(4-hydroxyphenyl)methane also referred to as 4,4′-methylidenebisphenol (bisphenol F).

The reaction product of a bis-phenol compound phenolics are mixtures. An average of between 1 and about 3.5 alkylol groups are provided in the bis-phenol-aldehyde adduct. Preferably an average of from 1.75-2.75 methylol groups are provided. Specific examples of the adducts formed from Bis-A include 2-methylol-4,4′-isopropylidene-diphenol; 2,2′-dimethylol-4,4′-isopropylidene-diphenol; 6-methylol-4,4′-isopropylidene-diphenol; 6,6′-dimethylol-4,4′-isopropylidene-diphenol; 2,6′-dimethylol-4,4′-isopropylidene-diphenol; 2,6,2′-trimethylol-4,4′-isopropylidene-diphenol; 2,6,6′-trimethylol-4,4′-isopropylidene-diphenol; and 2,6,2′,6′-tetramethylol-4,4′-isopropylidene-diphenol. The adduct is etherified in any conventional manner using a conventional processes. Preferred alcohols are at least C₄ and include straight chain alcohols with not more than about 8 carbons atom, for example, various butanols, pentanols, hexanols, heptanols, and octanols. The more preferred alcohols include n-butanol, n-pentanol, or n-hexanol. The preferred etherified bis-phenol adducts are commercially available commercially from Georgia-Pacific Resin Incorporated, Atlanta, Ga. One example adduct is found in GP-7550® resin (60% in n-butanol).

A protective colloid is used at from 2% to about 8% on dry solids basis of the bonding agent to stabilize the aqueous dispersion of the etherified bis-phenol adduct which is added to the phenolic resole after base catalyzed alkylol conversion. The three components can be directly combined and mixed at about 65° C.-75° C. with sufficient energy to form a uniform dispersion. Protective colloids include synthetic materials, such as poly(vinyl alcohol) and partially hydrolysed poly(vinyl acetate), semisynthetic materials such as water-soluble cellulose ethers, especially sodium carboxymethylcellulose and methylcellulose, and natural materials such as vegetable gum, proteins, and starches, especially guar gum, algin, carrageenan, gum acacia, gum tragacanth, and amylopectin. The invention will be described in further detail for the most preferred embodiment using a protective colloid of PVOH.

The preferred polyvinyl alcohol protective colloid is an aqueous solution polyvinyl alcohol having a molecular weight of between about 30,000 and about 50,000 and a degree of hydrolysis of at least about 85%. High molecular weight grades having relatively lower degree of hydrolysis result in higher viscosity, smaller particle size dispersions. A desired balance of viscosity and particle size is readily determinable by trial and error. Products in a wide range of molecular weight and hydrolysis level are available from the Air Products & Chemicals Company. PVOH having a molecular weight of about 31,000-50,000 and a degree of hydrolysis of about 87-89 percent is well suited. Etherified bis-phenol adduct is combined with the protective colloid under high shear agitation, and optional alcohol diluent.

The aqueous PVOH-phenolic dispersion is formed under conventional conditions with the use of a catalyst, such as hexamethylenetetramine or other catalyst commonly is used to catalyze the reaction of phenol and formaldehyde. Final mixture can be made by gradual addition of an aqueous PVOH solution to a hot mixture of the two phenolic resoles and organic cosolvents. A Ross® PD mixer equipped with a high speed disperser blade for particle size reduction and a planetary blade for blending high viscosity fluids is suitable. The initial water-in-oil dispersion eventually inverts to an oil-in-water dispersion, and the process conditions surrounding this inversion help control the particle size of the final product

Etherified bis-phenol adduct having a methylol functionality of from 1 to about 3.5 is present in the mixture of the curing agent on a solids basis in an amount of from 10 wt. parts to 55 wt. parts with 90 to 45 wt. parts of the hydrophilic phenolic resole. More preferably 20 wt. parts to 40 wt. parts of etherified bis-phenol is combined with 80 to 60 wt. parts of the hydrophilic phenolic resole.

Water miscible co-solvents can be used in the bonding agent to facilitate the blend of hydrophilic phenolic condensate and etherified bis phenol aldehyde adduct. Water miscible co-solvents include diethylene glycol butyl ether, 2-butoxyethanol in an amount within the range from about 0.01 wt % to about 10 wt. % of the bonding agent. In one example bonding agent, on dry weight basis, 157 parts of phenol-formaldehyde resole, 37 parts of butylated Bis A-formaldehyde adduct and 7 parts of PVOH as 20% aq. dispersion are combined to form a stable aq. dispersion. A commercial product containing a mixture of phenol-formaldehyde resole, butylated Bis A-formaldehyde adduct in a aq. PVOH is sold by Ga. Pacific under GP® grades. Methods for preparing the bonding agent are provided in detail from U.S. Pat. No. 5,548,015, incorporated herein by reference.

The bonding agent is utilized in the 1-coat adhesive in an amount of from 50% to 100% solids weight of the total dry wt. of adhesive. Preferably at least 60% by wt. of bonding agent is present. In one embodiment, 100% of the dry weight of the adhesive is the bonding agent. In other preferred embodiments, the adhesive comprises 70-80 weight parts of the bonding agent, 10- to 30 wt. parts of halogenated film former and 10-25 wt. parts of non-lead acid scavenger.

In a specific preferred embodiment the dry weight of adhesive is comprised of 1-3% of an aqueous dispersant, from 2-6% of a precipitated silica, from 10-30% of an acid scavenger, from 10-20% of titanium dioxide, 10-30% of a halogenated polymer film former, 50-80% of a phenolic resole comprising a phenol-aldehyde condensate, etherified bisphenol adduct and PVOH as a protective colloid.

Diluent/Carrier

The adhesive compositions of this invention are prepared by conventional means. For ease of application, as is conventional in this art, the components will be mixed and dispersed in an inert liquid diluents which are the primary carrier of the homogeneous, refined mixture of solids, and once the wet adhesive composition has been applied, can be readily removed by evaporation. Examples below are illustrative of the preferred liquid diluents being water. The amount of the diluent employed is that which provides a composition suitable for use as an adhesive. The organic solvent diluent/carrier amount will ordinarily be such as to provide a total solids content (TSC) ranging from about 5 to 80, preferably about 5 to about 40 percent by weight, and more preferredly from about 20 and 50%, but is not critical in that the control of dry film thickness is readily obtainable by control of solids and dependant on the chosen method of applying the wet adhesive conventionally in the art. Most preferably the aqueous adhesive percent solids level is around 30-40%.

Water used as a diluent requires for dispersion of finely divided solids components a conventional surfactant or dispersing agent. A preferred dispersing agent is a lignosulfonates including as a basic lignin monomer unit a substituted phenyl propane. These are commercially available under the trade designation as Marasperse® from Ligno Tech U.S.A. Dispersants and/or surfactants are used in an effective amount of from 1 to 3% by dry weight.

Adjuvants

If desirable, the adhesive compositions of the present invention may further comprise other optional additives that include, but are not limited to, pigments, e.g., TiO₂ inert filler material, e.g., clay, silicates; reinforcing fillers or fibers like carbon black, carbon fibers, glass fibers, and the like; and organosilane adhesion promoters, silane coupling agents. The amount of such addititives being within the ranges customarily employed. The adhesive compositions of the present invention may also contain a vulcanizing agent. The vulcanizing agent of the present invention can be any known vulcanizing agent which is capable of crosslinking elastomers at molding temperatures (140-200° C.). Preferred vulcanizing agents for use in the invention are selenium, sulphur, and tellurium, with selenium being most preferred. If employed, the vulcanizing agent is typically utilized in the present invention in an amount ranging from about 1 to 15, preferably from about 2 to 7, percent by dry weight of the total adhesive composition. Generally any type of carbon black can be utilized such as those having low to high DBP absorption (cc/100 g) as from about 50 to about 160 over a wide range of nitrogen adsorption (sq.m/g) as from about 20 to about 150. The amount of carbon black used in some embodiments is generally from about 0.5 to about 10 wt. %, dry weight basis.

The adhesive compositions of the present invention, are effective without the inclusion of a nitroso group-containing, or nitroso precursor compound, such as dinitrosobenzene (DNB) or are essentially absent a reactive nitroso group-containing or -generating compound. “Essentially absent” in this context is defined as present in a tramp impurity amount or an amount less than would form noticeable porosity in the cured rubber near the adhesive-elastomer bond interface.

Acid Scavenger

The adhesive compositions of the present invention contain a solid acid-scavenger in conjunction with halogenated film former. Acid scavengers include the oxides or salts of iron, nickel, cobalt, copper, zinc, calcium and aluminum, phosphates of zinc, oxides of cadmium, oxides of magnesium, oxides of lead, and oxides of zirconium. The suitable lead compounds include dibasic lead phthalate, monohydrous tribasic lead maleate, and tetrabasic lead fumarate. The non-lead metal scavengers are preferred, in all embodiments of the adhesives of the present invention. Non-lead metal oxides, metallic phosphate salts, and metal carbonates of zinc or calcium such as calcium carbonate, aluminum phosphate, zinc phosphate, and zinc oxide, and mixtures of any of these are more preferred. Most preferred is a mixture of 55-95 wt. % aluminum phosphate and 5-45% zinc oxide. The absence of added lead compound is more preferred. “absence of added” means that a lead compound is not intentionally added when preparing the adhesive. The presence of analytically detectable levels of lead as tramp-, or cross-contamination of lead from raw materials or equipment used to make other lead-containing products is included within the purview of the present invention. The preferred maximum lead level is 1000 ppm.

The phosphates as phosphoric acid salts usable in the preparation of metal phosphate component are, for example, aluminum phosphate, zinc phosphate, and aluminum dihydrogentripolyphosphate and mixtures. Environmentally acceptable acid scavengers are based on metal molybdates, -phosphates, -oxides-, -metaborates and the like and combinations. Good non-lead acid scavenging corrosion inhibitors for use in the present invention are zinc molybdate/phosphate, zinc phosphate and barium, calcium, zinc borate and zinc aluminum phosphate. A listing of acid scavengers is provided in The Handbook of Chemistry and Physics, 62nd Ed. CRC Press, Inc. Boca Raton, Fa., Editor Weast and Astle in the Chapter on Physical Constants of Inorganic Compounds, which is incorporated herein by reference.

Forms of the preferred zinc-containing acid scavengers may be supplied by way of any convenient source like in the form of the metal oxide, hydroxide, carbonate, zinc phosphate, zinc moly/phosphate, other than chromates. A suitable form is by way of a salt such as the zinc carbonate or zinc phosphate. Likewise, the zinc orthophosphate may be used.

Preferred is zinc/aluminum phosphate which can be obtained by dispersing particles of aluminum dihydrogentripolyphosphate in a solution containing a zinc whereby the zinc ion is deposited as the hydroxide on the surface of the particles of aluminum dihydrogentripolyphosphate by changing the pH of the solution from weakly acidic to the alkaline side by amines. Thereafter, the zinc hydroxide on the surface is converted to zinc oxide by filtering, washing with water, drying and heat-treating. The substances capable of delivering a Zn ion for preparing a solution containing a Zn ion include zinc chloride, zinc hydroxide, zinc nitrate, zinc carbonate, zinc sulfate etc., phosphates treated with Zn compounds, particularly, aluminum dihydrogentripolyphosphate can provide excellent durability of adhesive properties.

Zn components are included in or coated on the particles of phosphates by, for example, adsorption or absorption. The phosphates treated with Zn compounds can be used alone or in any mixtures with aluminum and/or zinc oxides.

The acid-scavenger is utilized in an amount ranging from about 2 to 35%, preferably from about 5 to 30%, and more preferably 10 to 25% of the dry weight of the adhesive composition. The preferred non-lead acid scavengers effective in place of lead compounds are used at from to 20 phr to 200 phr (100 weight parts of halogenated film former). Preferably, non-lead acid scavenger is used at from 70 phr to 120 phr of halogenated film former. A particularly effective version is zinc/aluminum phosphate, commercially available from Heubach Company as Heucophos® ZPA.

Silica

In the embodiments containing a halogen-containing polymer film former, pre-bake resistance is needed. However it has been found that in conjunction with halogen-containing film forming polymers, precipitated silicas and preferably amorphous precipitated silicas yield good pre-bake resistance whereas fumed silicas do not provide essential pre-bake resistance. If any fumed silica is utilized, the amount thereof is low, i.e. generally less than about 5, desirably less than about 3 weight %. The precipitated silicas are generally spherical and have an average diameter of from about 0.005 or about 0.010 to about 0.030, or about 0.050, or about 0.100 and desirably from about 0.015 to about 0.025 micrometers. The surface area is generally from about 130 to about 170 and preferably from about 140 to about 150 square meters per gram. Examples of such commercially available precipitated silicas include Cabosil CP304 made by Cabot Corporation of Kokoma, Ind.; Aerosil 200 made by Degussa Corporation of Ridgefield Park, N.J. with various products such as HiSil® 233 made by PPG, Inc. of Pittsburgh, Pa., being especially preferred.

The preferred precipitated silicas, for example HiSil® 233 as well as other HiSil® 200 series silicas, are a synthetic white, amorphous silica (silicone dioxide) powders and pellets. They are classed as wet-process, hydrated silicas because they are produced by a chemical reaction in a water solution, from which they are precipitated as ultra-fine, spherical particles having an average diameter as noted above. The particles tend to agglomerate in a loose structure which looks like a grape cluster when magnified by an electron microscope. The surface areas of such precipitated silicas are very large, as noted above. Generally, less than 0.03% by weight of residual particles are retained on a 100 mess U.S. standard screen.

The amount of the precipitated silica on a dry weight basis is generally from about 5 to about 30% by weight and desirably from about 7 to 20% by weight on the dry weight of the adhesive.

Substrate

The surface to which the material is bonded can be any primer or unprimed surface capable of receiving the adhesive such as a glass, plastic, or fabric surface, and is preferably a metal surface selected from any of the common structural metals such as iron, steel (including stainless steel), lead, aluminum, copper, brass, bronze, MONEL metal alloy (Huntington Alloy Products Div., International Nickel Co., Inc.), nickel, zinc, including treated metals such as phosphatized steel, galvanized steel, and the like. Prior to bonding, a metal surface is typically cleaned according to one or more methods known in the art such as degreasing, grit-blasting and zinc-phosphatizing. The substrate includes woven or nonwoven glass fabrics, or continuous rovings of glass, such as E-glass; fabrics, fibers or rovings of polyamides, polyester, aramids, e.g., Kevlar, a trademark of E. I. du Pont de Nemours Co., (Inc.), of Wilmington, Del., carbon fibers, and stainless steel fibers; ceramics, metals, and the like shaped or in foils or coils. The typical articles of manufacture comprising a peroxide-cured elastomer bonded to metal with the adhesives of the invention are HNBR-glass fiber-rubber drive belts, rubber rolls, engine mounts, metal gaskets and seals for automotive, industrial and aerospace devices.

As noted above, the preferred embodiments for the rubber to metal adhesive compositions of the present invention exhibit pre-bake resistance. Pre-bake resistance is defined as a capability of tolerating a pre-bake cycle of about 3 or about 6 minutes and especially about 9 minutes at 380° F. and still maintain the capability of providing a high percentage (80%-100%) rubber tearing or retention on a rigid substrate after vulcanization of the rubber compound. That is, even though heated for up to 3, 6, or 9 minutes at 380° F. before any cure of the peroxide cured rubber, after cure of the rubber, the adhesive does not fail but rather generally at least 80%, desirably at least 85% or 90% and preferably at least 95% or 100% of the bonded rubber tears during testing of the laminate. Another important advantage is that when loading molds which are preheated to a molding temperature of up to about 400° F., adhesive coated inserts can be exposed to these temperatures for up to several minutes prior to rubber contact and cure initiation. The adhesive must resist pre-curing as a result of such heat exposure. Should the adhesive be pre-cured, the same will typically fail at the rubber-adhesive interface and not provide for desired rubber retention when destructively tested. Sweep resistance is also desirable with regard to adhesive coated seals, and is defined as the resistance to adhesive movement when unvulcanized rubber moves across the pre-baked adhesive during a molding step.

A variety of methods of bonding fibers as the substrate to rubber compounds or mixes are known, among which there is a well known method wherein fibers are treated with so-called RFL solutions, namely aqueous mixtures of resorcinol/formalin resins and rubber latices, and placed in contact with rubber compounds, and then the rubber compounds are vulcanized together with the fibers. For instance, a method is disclosed in Japanese Patent Laid-open No. 49-96048 in which an RFL solution is used which contains a chlorohydrin rubber latex and a chloroprene rubber latex together with resorcinol/formalin resin for bonding polyamide fibers to chloroprene rubber mixes.

A further method is also disclosed in Japanese Patent Laid-open No. 59-89375 wherein an RFL solution is used which is composed of an aqueous mixture of a chloroprene/dichlorobutadiene copolymer latex and resorcinol/formalin resin.

The adhesives herein provide excellent, durable bonding to difficult to adhere high saturation or complete saturation rubbers such as the aforementioned HNBR, rubber, ethylene/propylene rubber, chlorinated polyethylene, chlorosulfonated polyethylene, epichlorohydrin rubber or fluorocarbon rubber.

Preparation and Use

The adhesive compositions of the present invention may be prepared by any method known in the art, but are preferably prepared by combining and milling or shaking the ingredients and solvent or water vehicle in a ball-mill, sand-mill, ceramic bead-mill, steel bead-mill, high speed media-mill, or the like. The adhesive compositions may be applied to a surface to be bonded by spraying, dipping, brushing, wiping, roll-coating or the like, after which the adhesive composition is permitted to dry. The adhesive composition is typically applied in an amount sufficient to form a dry film thickness ranging from about 0.1 to 2.0 mils, preferably from about 0.2 to 0.8 mils. Adhesive dry film thickness above 2 miles causes cohesive failure, while film thickness less than 0.1 mills can generate failure due to inadequate surface coverage. In the case of a two-coat adhesive composition, the adhesive is applied in a similar manner over the primer coat which has been permitted to completely dry.

The 1-coat adhesive composition of the invention is especially adapted to be utilized to bond a peroxide-cured elastomeric material to a metal surface. The composition may be applied any substrate surface, e.g., to the metal surface, by spraying, dipping, brushing, wiping or the like, after which the wet adhesive coating is permitted to dry. The present adhesive compositions have a particular affinity for peroxide-cured elastomers in substantial contact with the elastomer. “At least substantial contact” herein refers to physical contact between the adhesive composition and the elastomeric substrate. The adhesive composition is typically applied to metal surfaces and the coated metal surface and elastomeric substrate are then brought together under heat and pressure for substantial contact and bonding completed in the rubber vulcanizing procedure. In some cases, it may be desirable to preheat (35-80° C.) the metal surface prior to application of the adhesive composition to assist in drying of the adhesive composition. The coated surface of the metal and the elastomeric substrate are typically brought together under a pressure of from about 20.7 to 172.4 Mega Pascals (MPa), preferably from about 20 MPa to 50 MPa. The resulting rubber-metal assembly is simultaneously heated to a temperature of from about 140° C. to about 200° C., preferably from about 150° C. to 170° C. The assembly should remain under the applied pressure and temperature for a period of from about 3 minutes to 60 minutes, depending on the vulcanizable elastomer cure rate and thickness of the elastomer substrate. This process may be carried out by applying the rubber substrate as a semi-molten material to the metal surface as in, for example, an injection-molding process. The process may also be carried out by utilizing compression molding, transfer molding or autoclave curing techniques. After the process is complete, the bonded adhesive and elastomer are fully vulcanized and ready for use in a final application, such as engine mount, damper, or belting, to name a few typical uses.

### EXAMPLES

The following examples are disclosed in order to further illustrate and fully disclose the invention and are not intended to limit in any manner the scope of the invention which is defined by the claims.

Adhesive Tests F

Primary Adhesion

Bonded parts are pulled to destruction according to ASTM Test D429-Method B. Parts are tested in peel with a peel angle of 45 degrees. The test is conducted at room temperature with a specified test speed of, for example 2 or 20 inches per minute. After the bonded part fails, the peak peel strength value (measured in pounds per lineal inch) and the percent rubber retention on the adhesive coated area of the part are measured.

72-Hour Salt Spray

Bonded parts are buffed on the edges with a grinding wheel. The rubber is then tied back over the metal with stainless steel wire so as to stress the bonded area. This exposes the bond line to the environment. Failure is initiated by scoring the bond line with a razor blade. The parts are then strung on stainless steel wire and placed in a salt spray chamber. The environment inside the chamber is 100° F., 100 percent relative humidity, and 5 percent dissolved salt in the spray, which is dispersed throughout the chamber. The parts remain in this environment for 72 hours. Upon removal, the rubber is peeled from the metal with pliers. The percent rubber retention on the parts is then measured.

2-Hour Boiling Water

Bonded parts are prepared the same way as they are for the salt spray test; however, in this test, the parts are placed in a beaker filled with boiling tap water. The parts remain in this environment for 2 hours. Upon removal, the rubber is peeled from the metal with pliers. The percent rubber retention on the parts is then measured.

7-Day Room Temperature Water-Immersion

Bonded parts are prepared the same way as they are for the salt spray test. In this test, the parts are placed in a beaker filled with tap water which is at room temperature. The parts remain in this environment for 7 days. Upon removal, the rubber is peeled from the metal with pliers. The percent rubber retention on the part is then measured.

The results of the above tests are set forth in tables below. In the data, reference is made to failure in the rubber body (R). Failure is expressed in terms of percent, and a high percent of failure in the rubber is desirable since this indicates that the adhesive bond is stronger than the rubber itself.

% DRY WEIGHT

| | EXAMPLE 1 | EXAMPLE 2 | EXAMPLE 3 | EXAMPLE 4 |
|---|---|---|---|---|
| | 71C | 77C | 77H | 3T |
| Marasperse ® | 2.0 | 2.0 | 2.0 | 0.0 |
| Zinc oxide | 15.0 | 20.0 | 29.0 | 0.0 |
| TiO₂ | 19.2 | 4.0 | 0.0 | 0.0 |
| Cabosil ® M-5 | 3.8 | 4.0 | 4.0 | 0.0 |
| Resole* | 60.0 | 70.0 | 65.0 | 100.0 |
| TOTALS | 100.0 | 100.0 | 100.0 | 100.0 |

*PVOH dispersion of phenolic-aldehyde resole condensate and butyl etherified bis-phenol A adduct.

Bonded rubber-to-metal assemblies are prepared in accordance with the Examples 1-4 respectively, except the coated coupons are exposed to prebake or precure heat conditions. When prebaked for a specified time, the adhesive coated parts are exposed to the molding temperature for that specified time in minutes before the rubber is injected into the cavity. This simulates actual production conditions and helps determine if the adhesive remains active enough to successfully bond the rubber compound.

TABLE 1
Performance testing on Copper plate/Peroxide cured EPDM

| | Primary | Primary | 48 hours | 96 hours |
|---|---|---|---|---|
| | adhesion 0′ | adhesion 4′ | autoclave 50 | autoclave 50 |
| Example | prebake | prebake | psi | psi |
| 1 (71C) | 90R, RC | 100R | 99R,RC | 100R |
| 2 (77C) | 97R,RC | 98R,RC | 99R, RC | 100R |
| 3 (77H) | 94R,RC | 99R,RC | 100R | 100R |
| 4 (3T) | 100R | 100R | 100R | 100R |

Failure is expressed in terms of percent, and a high percent of failure in the rubber is desirable since this indicates that the adhesive bond is stronger than the rubber itself.

### Example 5

To a base aqueous formula consisting of: 75 dry parts of a mixture of a phenol-aldheyde condensate, butyl etherified bis-phenol aldehyde adduct and PVOH as the protective colloid, and 25 dry parts Hypalon® 4500 chlorosulfonated polyethylene latex, the following acid scavengers listed below were added. The total solids content of each was approx. 38%. Adhesive was spray applied at 155° F. to a dry film thickness of 0.001 inch. EPDN elastomers were compression molded to dry adhesive treated copper coupons and cured at 340° F. The test was an environmental test in an autoclave @ 50 p.s.i. for 100 hours. Peroxide cured EPDM was adhered to a blasted copper substrate during vulcanization of the rubber using a 1.0 mil dry film thickness (DFT) for each adhesive. Parts were tested by putting them in an autoclave under 50 psi steam heat for 100 hours. The parts were then torn apart with pliers to determine percent rubber retained on the copper substrate.

TABLE 2
Formulations - dry wt. parts acid scavenger

| | | Zinc | Lead | Zn/Al | | Total dry |
|---|---|---|---|---|---|---|
| | none | oxide | phosphate | Phosphate | Hydrotalcite | parts |
| Control | 0 | | | | | 100 |
| 6A | | | | | | |
| 6B | | 5 | | | | 105 |
| 6C | | 10 | | | | 110 |
| 6D | | 15 | | | | 115 |
| 6E | | | 5 | | | 105 |
| 6F | | | 10 | | | 110 |
| 6G | | | 15 | | | 115 |
| 6H | | | | 5 | | 105 |
| 61 | | | | 10 | | 110 |
| 6J | | | | 15 | | 115 |
| 6K | | | | | 5 | 105 |
| 6L | | | | | 10 | 110 |
| 6M | | | | | 15 | 115 |

TABLE 3
Results with 0′ prebake - % EPDM retention on substrate

| | | | | Zn/Al | |
|---|---|---|---|---|---|
| | nothing | Zinc oxide | Dyphos(lead) | Phosphate | Hydrotalcite |
| Control 6A | 15% | | | | |
| | rubber | | | | |
| 6B | | 40% rubber | | | |
| 6C | | 8% rubber | | | |
| 6D | | 75% rubber | | | |
| 6E | | | 1% rubber | | |
| 6F | | | 8% rubber | | |
| 6G | | | 0% rubber | | |
| 6H | | | | 85% rubber | |
| 6I | | | | 43% rubber | |
| 6J | | | | 98% rubber | |
| 6K | | | | | 5% rubber |
| 6L | | | | | 3% rubber |
| 6M | | | | | 0% rubber |

TABLE 4
Results with a 5′ prebake- % EPDM retention on substrate

| | | | | Zn/Al | |
|---|---|---|---|---|---|
| | none | Zinc oxide | Dyphos(lead) | Phosphate | Hydrotalcite |
| Control 6A | 85% | | | | |
| | rubber | | | | |
| 6B | | 40% rubber | | | |
| 6C | | 5% rubber | | | |
| 6D | | 50% rubber | | | |
| 6E | | | 10% rubber | | |
| 6F | | | 8% rubber | | |
| 6G | | | 2% rubber | | |
| 6H | | | | 97% rubber | |
| 6I | | | | 100% rubber | |
| 6J | | | | 100% rubber | |
| 6K | | | | | 0% rubber |
| 6L | | | | | 0% rubber |
| 6M | | | | | 0% rubber |

As can be seen, zinc/aluminum phosphate provided surprisingly higher % rubber retention in primary adhesion tests at the levels tested with or without a prebake.

### Example 6

To 75 weight parts of the phenolic resole used in Examples 1-4, the following listed components were added.

TABLE 5

| | 10 parts | 15 parts | 20 parts | 25 parts |
|---|---|---|---|---|
| Film Former | Hypalon ® 4500 | Hypalon ® 4500 | Hypalon ® 4500 | Hypalon ® 4500 |
| Acid scavenger | | | | |
| 20 parts | 6D | 6E | 6I | 6M |
| Zn/Al phos. | | | | |
| 15 parts | 6C | 6F | 6J | 6N |
| Zn/Al phos. | | | | |
| 10 parts | 6B | 6G | 6K | 6O |
| Zn/Al phos. | | | | |
| 0 parts | 6A | 6H | 6L | 6P |
| Zn/Al phos. | | | | |

Primary adhesion of adhesives 6A-6P bonded to copper—EPDM specimens were pulled at 2″ per minute @ 45 degree angle at room temperature. Percent rubber retained on parts is listed below.

TABLE 6

| | 10 parts | 15 parts | 20 parts | 25 parts |
|---|---|---|---|---|
| | Hypalon 4500 | Hypalon 4500 | Hypalon 4500 | Hypalon 4500 |
| 20 parts | 7D | 7E | 7L | 7M |
| Zn/Al phos. | 100% Rubber | 98% Rubber | 100% Rubber | 100% Rubber |
| 15 parts | 7C | 7F | 7K | 7N |
| Zn/Al phos. | 60% Rubber | 75% Rubber | 90% Rubber | 100% Rubber |
| 10 parts | 7B | 7G | 7J | 7O |
| Zn/Al phos. | 85% Rubber | 78% Rubber | 88% Rubber | 80% Rubber |
| 0 parts | 7A | 7H | 7I | 7P |
| Zn/Al phos. | 70% Rubber | 5% Rubber | 5% Rubber | 48% Rubber |

As can be seen a combination of 15-20 dry weight parts of a zinc/aluminum phosphate in combination with from 10 to 25 dry weight parts of chlorosulfonated polyethylene provides higher % rubber retention in the peel test.

### Example 7

### Comparison of Different Phenolic Resoles

Aqueous 100% phenolic resole bonding agent of example 1 was applied as approx. 1.0 mil dry film thickness to zinc phosphatized steel and bonded to EPDM. Primary Adhesion testing was according to the above examples in peel at 2″ per minute.

TABLE 7

| | EPDM #1 PEROXIDE CURED | | EPDM #2 PEROXIDE CURED | |
|---|---|---|---|---|
| | 0′ PREBAKE | 2′ PREBAKE | 0′ PREBAKE | 2′ PREBAKE |
| | 7A | 7B | 7C | 7D |
| Phenolic mix. | 15# 95R | 25# 99R | 21# 15R | HP 0R |
| Example 1 | | | | |
| BKUA 2370 | 14# 15R | 23#75R | 18# 5R | HP 0R |
| Phenolic C | 18# 5R | 18# 40R | 16# 5R | HP 5R |
| Phenolic D | 16# 50R | 18# 15R | 21# 18R | HP 30R |

% Dry Weight/Blends Used as Adhesives for Bonding Rubber

TABLE 8

| | A | B | C | D | E | F | G | H |
|---|---|---|---|---|---|---|---|---|
| Phenolic mixture from | 75.0 | 75.0 | 75.0 | 75.0 | | | | |
| Ex. 1 | | | | | | | | |
| BKUA 2370 | | | | | 75.0 | 75.0 | 75.0 | 75.0 |
| HYPALON ® 48 latex | 25.0 | | | | 25.0 | | | |
| HYPALON ® 45 latex | | 25.0 | | | | 25.0 | | |
| Chlorinated nat. latex | | | 25.0 | | | | 25.0 | |
| Carbox. SBR latex | | | | 25.0 | | | | 25.0 |

TABLE 9
Primary Adhesion

| | EPDM #1 | | EPDM #2 | | NBR Sulfur | |
|---|---|---|---|---|---|---|
| | PEROXiDE | | PEROXiDE | | Cured | |
| | 0′ PRE | 2′ PRE | 0′ PRE | 2′ PRE | 0′ PRE | 2′ PRE |
| ADHESIVE A | 26#97R | 17#50R | 22#5R | 33#10R | 87#18R | HP 0R |
| ADHESIVE B | 23#98R | 25#100R | 31#90R | R50#100R | 54#10R | HP 0R |
| ADHESIVE C | 21#95R | 21#65R | 17#2R | 18#0R | 80#30R | HP 0R |
| ADHESIVE D | 19#99R | HP 0R | 18#10R | 19#0R | HP 0R | HP 0R |
| ADHESIVE E | 20#85R | 20#88R | 21#13R | 38#65R | 95#83R | HP 0R |
| ADHESIVE F | 25#98R | 20#100R | 33#50R | 39#99R | 77#35R | HP 0R |
| ADHESIVE G | 17#83R | 20#30R | 22#0R | 22#0R | 67#18R | HP 0R |
| ADHESIVE H | 12#0R | HP 0R | 20#15R | 18#0R | 79#25R | HP 0R |

It is understood that the foregoing description of preferred embodiments is illustrative, and that variations may be made in the present invention without departing from the spirit and scope of the invention. Although illustrated embodiments of the invention have been shown and described, a latitude of modification, change and substitution is intended in the foregoing disclosure, and in certain instances some features of the invention will be employed without a corresponding use of other features. Accordingly, it is appropriate that the appended claims are to be construed in a manner consistent with the scope of the invention.

What is claimed is:

1. An bonded article comprising a peroxide-cured elastomer bonded to a substrate, and as a single organic bonding layer between said elastomer and substrate, said adhesive layer is the residue of an aqueous adhesive comprising a bonding agent comprising a phenol-aldehyde resole, an etherified bis-phenol adduct dispersed with an aqueous protective colloid, and wherein said adhesive exhibits rubber tearing bonds between the vulcanizate of said peroxide-cured elastomer and substrate with said adhesive therebetween.

2. The article of claim 1 wherein said bonding agent comprises 90 to 55% of said phenol-aldehyde resole and from 10 to 55% of said etherified bis-phenol adduct on weight basis of said bonding agent.

3. The article of claim 1 further comprising a metallic acid scavenger and a film former.

4. The article of claim 3 wherein said metallic acid scavenger is selected from the group consisting of oxides or salts of iron, nickel, cobalt, copper, zinc, calcium and aluminum, phosphates of zinc, oxides of cadmium, oxides of magnesium, oxides of lead, and oxides of zirconium, and mixtures thereof.

5. The article of claim 3 wherein the halogenated polyolefin is selected from the group consisting of chlorinated natural rubber, polychloroprene, chlorinated polychloroprene, chlorinated polybutadiene, polyhexachloxopentadiene butadiene/halogenated cyclic conjugated diene adducts, chlorinated butadiene styrene copolymers, chlorinated ethylene propylene copolymers and ethylene/propylene/non-conjugated diene terpolymers, chlorinated polyethylene, chlorosulfonated polyethylene, brominated poly(2,3-dichloro-1,3-butadiene), copolymers of .alpha.-haloacrylo-nitriles and 2,3-dichloro-1,3-butadiene, and chlorinated poly(vinyl chloride).

6. The article of claim 3 wherein said film former is a chlorosulfonated polyethylene and said acid scavenger comprises a metal other than lead.

7. The article of claim 1 further comprising a film former selected from the group consisting of chlorinated natural rubber, polychloroprene, chlorinated polychloroprene, chlorinated polybutadiene, a chlorinated butadiene styrene copolymer, chlorinated ethylene propylene copolymer, a chlorinated ethylene/propylene/non-conjugated diene terpolymer, chlorinated polyethylene, chlorosulfonated polyethylene, and a copolymer of α-chloroacrylonitrile and 2,3-dichloro-1,3-butadiene, and mixtures thereof.

8. The article of claim 6 wherein the acid scavenger comprises a metal salt or oxide selected from the group consisting of the oxides and phosphates of zinc, oxides and phosphates of cadmium, oxides of magnesium, oxides and phosphates of aluminum, oxides of zirconium, zirconium salts, and combinations thereof.

9. The article of claim 3 wherein the acid scavenger comprises a lead-containing compound selected from the group consisting of dibasic lead phthalate, monohydrous tribasic lead maleate, tetrabasic lead fumarate, dibasic lead phosphite, basic lead carbonate, lead oxide, lead dioxide and combinations thereof.

10. The article of claim 7 wherein said adhesive further comprises a supplemental polymeric film-forming other than said film former, in an amount ranging from about 5 to 40 wt. %.

11. An aqueous one-coat adhesive exhibiting rubber tearing bonds to peroxide cured elastomer bonded to a substrate, on a weight basis consisting essentially of: 1-3% of an aqueous dispersant, from 2-6% of a precipitated silica, from 10-30% of an acid scavenger, from 0-20% of titanium dioxide, 10-30% of a halogenated film forming polymer, and 50-80% of a bonding agent which comprises a 45 to 90 wt. % of phenolic resole and from 10 to 55% of an etherified bisphenol adduct dispersed in an aqueous protective colloid, and water to 100%.

12. An article comprising a peroxide-cured elastomer bonded to a substrate, and as a single adhesive layer between said elastomer and substrate, said adhesive layer consisting of an aqueous PVOH dispersed mixture of a phenolic resole and etherified bis-phenol adduct, wherein said adhesive exhibits rubber tearing bonds between the vulcanizate of said peroxide-cured elastomer and substrate with said adhesive therebetween.

13. An article comprising a peroxide-cured elastomer bonded to a metallic substrate, and as a single adhesive layer between said elastomer and metallic substrate, said adhesive layer is the residue of an aqueous adhesive consisting of 70-80 weight parts of a bonding agent, said bonding agent comprises a phenolic resole, etherified bis-phenol adduct and PVOH dispersion, 10- to 30 wt. parts of halogenated film former and 10-25 wt. parts of zinc/Al phosphate, and optional pigment and adjuvants.

14. The article of claim 1 wherein said substrate is selected from the group consisting of iron, steel, lead, aluminum, copper, brass, bronze, nickel, zinc, phosphatized steel, and galvanized steel.

15. The article of claim 1 wherein said adhesive further comprises on a dry weight basis dry weight of adhesive 1-3% of an aqueous dispersant, from 2-6% of a precipitated silica, from 10-30% of an acid scavenger, from 10-20% of titanium dioxide, 10-30% of a halogenated polymer film former, and from 50-80% said bonding agent.
